(19) United States
(12) Patent Application Publication
(10) Pub. No.: US 2023/0065646 A1
(43) Pub. Date: Mar. 2, 2023

(54) METHODS FOR CONTROLLING OFF-FLAVORS IN LOW-ALCOHOL AND NONALCOHOLIC BEER

(71) Applicant: COORS BREWING COMPANY, Milwaukee, WI (US)

(72) Inventors: Lee Arthur GRIFFITHS, Staffordshire (GB); Genevieve C. UPTON, Camelford Cornwall (GB)

(21) Appl. No.: 17/796,595

(22) PCT Filed: Jan. 29, 2021
(86) PCT No.: PCT/US2021/015870

§ 371 Date: Jul. 29, 2022

Related U.S. Application Data
(60) Provisional application No. 62/968,269, filed on Jan. 31, 2020.

(51) Int. Cl. A23L 2/52; A23L 2/38; C12C 12/04

(52) U.S. Cl. CPC A23L 2/52; A23L 2/382; C12C 12/04

(57) ABSTRACT

Methods, devices, and systems are provided for controlling off-flavors of low-alcohol and nonalcoholic beer. The formation of Strecker aldehydes is limited during the processing and subsequent storage of low-alcohol or nonalcoholic beer. Limiting the formation of Strecker aldehydes provides an improved sensory perception and taste through a reduction in worry flavors.

### CROSS REFERENCE TO RELATED APPLICATION

The present application claims the benefit of and priority, under 35 U.S.C. § 119(e), to U.S. Provisional Application Ser. No. 62/968,269, filed Jan. 31, 2020, entitled “Methods for Controlling Off-Flavors in Low-Alcohol and Nonalcoholic Beer,” the entire disclosure of which is hereby incorporated herein by reference, in its entirety, for all that it teaches and for all purposes.

### BACKGROUND

The present disclosure is generally directed to brewing beer, in particular, toward controlled processes for brewing low-alcohol and nonalcoholic beer.

Defining beer flavor is a complex problem because there are hundreds of compounds present. Some of these compounds are present at levels that exceed the sensory threshold but are below the detection threshold of most gas chromatographs. Some studies show that there are just over 100 separately identifiable flavor elements, of which 39, or so, are present in most beers (with others being less frequent or off-flavors). Of these 39, or so, key flavor attributes in beer, 15 can be explained (e.g., as alcoholic, estery, and diacetyl), 20 can be partly explained (e.g., as hoppy, malty, and worty) and 10 cannot be explained (e.g., as spicy, woody, and grainy). The problem is further complicated by the interactions between the flavoring substances and the matrix and the chemical changes in beer with time, temperature and oxygen content.

In general, nonalcoholic beers and reduced alcohol beers display several problems such as freezing, improper foaming, increased risk of microbial contamination, immature flavor profile and off-flavors associated with the reduction or elimination of alcohol.

A recent paper studied the temporal flavor dominance during consumption of beers with varying alcohol content. See, e.g., Missbach, B., Majchrzak, D., Sulzner, R., Wansink, B., Reichel, M., Koenig, J., (2017) “Exploring the Flavor Life Cycle of Beers with Varying Alcohol Content,” Food Sci Nutr. 2017: 5: 889— 895 (“Missbach”). In Missbach, the authors reported similar temporal flavor dominance of bitterness but differences in worty off-flavor, malty flavor and astringency mouthfeel. The authors showed that the presence of ethanol has an effect in the detection of worty off-flavors.

Worty off-flavor is the most prominent undesirable off-flavor in low-alcohol or nonalcoholic beers. This worty off-flavor is sometimes described as being potato-like or unfermented in taste. Several carbonyl compounds, namely 3-methylbutanal, 2-methylbutanal and 2-methylpropanal contribute to the worty off-flavors. An additional problem arises from the fact that the compounds that are usually described as having a worty flavor can be formed during beer aging due to oxidation.

### DETAILED DESCRIPTION

Although there is a discrepancy on the number of compounds reported, there seems to be agreement that worty flavor arises from the combined sensory perception of Strecker aldehydes. Individually each of the compounds have a distinct sensory note, ranging from malty, chocolate to fruity but when combined, the worty character arises as a construct of the different sensory notes. Another point of contention is the value of the sensory threshold, usually the values reported in the literature are obtained in an alcoholic beer matrix and depending on the study, different authors report different values.

Strecker aldehydes can be formed during malting, mashing, and boiling via the Strecker degradation of amino acids or via Amadori rearrangement of wort sugars with amino acids. During fermentation, the Strecker aldehydes are reduced to higher alcohols and then transformed into esters or bound with sulphites. During storage, the higher alcohols can be oxidized again to Strecker aldehydes, additionally, they can be generated from the degradation of iso-α-acids.

In regular alcoholic beer production, the Strecker aldehydes are bio-transformed naturally by the yeast into alcohols by a number of enzymes. Enzymatic reduction of Strecker aldehydes to alcohols is temperature dependent but may be limited to a maximum of 60% to 85% of the initial concentration. Even at low temperatures, of around 0° C., yeast can partially remove wort aldehydes yet, due to the low flavor threshold, the remaining aldehydes can impart an unpleasant worty flavor to the final beer.

The presence of ethanol in beer has a multi-modal effect, it provides aroma and flavor, warming sensation, body, astringency and can act as a flavor enhancer. Ethanol is also a precursor for the formation of esters which contribute to the flavor balance of the beer and mask the worty flavors. In a paper studying the effects of alcohol-free beer, the authors proffered that the absence of ethanol in beer has the effect of making a dull flavor (e.g., worty taints, etc.) that are perceivable at considerably lower than threshold levels. See, e.g., Sohrabvandi, S., Mousavi, M., Razavi, S., Mortazavian, A., and Rezaei, K., (2010) “Alcohol-Free Beer: Methods of Production, Sensorial Defects, and Healthful Effects,” Food Rev. Int. 26:335-352 (“Sohrabvandi”).

It is with respect to the above issues and other problems that the embodiments presented herein were contemplated. It is an object the present disclosure to control the worty off-flavors in low-alcohol and nonalcoholic beer. The methods of control described herein limit the formation of Strecker aldehydes during the processing and subsequent storage of low-alcohol or nonalcoholic beer to prevent worty off-flavor. In one embodiment, the method describes limiting amino acid precursors to Strecker Aldehydes. For example, controlling the free amino nitrogen (“FAN”) content and subsequent levels of Strecker aldehydes by choice of malted barley for use in low-alcohol and nonalcoholic beer applications also limits the formation of worty character both in fresh and aged product with these differences in starting levels tracking all the way through the brewing process.

Limitation of Amino Acid Precursors to Strecker Aldehydes:

In some embodiments, monitoring and paying careful attention to the levels of protein contained within malted barley as characterized through measurement of FAN beer production is described. FAN may be controlled to limit the formation of polyphenol-protein complexes which lead to presence of chill and permeant haze in beer upon storage. FAN is formed from bound nitrogen during the malting process where proteins are broken down. In addition to simple breakdown into amino acids, oxidation and Strecker aldehyde formation occurs during the malting process leading to appreciable levels of staling Strecker aldehydes in some malt types. In normal (e.g., alcoholic) beer brewing this formation is not considered a problem as these aldehydes are reduced by the reductive processes found in the brewing process. However, the inventors of the instant application developed a process whereby the limitation of FAN content and subsequent levels of Strecker aldehydes by choice of malted barley for use in nonalcoholic and/or low-alcohol beer applications also limits the formation of worty character both in fresh and aged product with these differences in starting levels tracking all the way through the brewing process.

Table 1, below, shows the difference in Strecker aldehyde levels in a variety of malt types. As described herein, a change in the composition of the grist was performed by the inventors to give lower levels of Strecker aldehydes at the start of the brewing process. The calculated levels in the grist for a typical brew of the color and flavor required, versus a reduced aldehyde selection shown in Table 2.

TABLE 1

| | Level | | | | | Unmalted |
|---|---|---|---|---|---|---|
| Staling Aldehydes | Amount | Malt #1 | Malt #2 | Malt #3 | Malt #4 | Barley |
| 2-Methylpropanal | μg/kg | 9700 | 2202 | 17359 | 104029 | 292 |
| 2-Methylbutanal | μg/kg | 4579 | 801 | 9007 | 73270 | 132 |
| 3-Methylbutanal | μg/kg | 7785 | 1489 | 12781 | 68036 | 122 |
| Pentanal | μg/kg | 133 | 104 | 117 | 176 | 253 |
| Hexanal | μg/kg | 1312 | 290 | 551 | 650 | 671 |
| 2-Furfural | μg/kg | 1581 | 271 | 720 | 46161 | 115 |
| Heptanal | μg/kg | 24.6 | 14.3 | 17.7 | 38.4 | 17.9 |
| Methional | μg/kg | 5564 | 1035 | 9768 | 8138 | 24.2 |
| Octanal | μg/kg | 8.9 | 8.1 | 8.9 | 21.7 | 8.7 |
| Benzaldehyde | μg/kg | 85.4 | 65.8 | 89.9 | 170 | 23.7 |
| Phenylacetaldehyde | μg/kg | 2772 | 626 | 2811 | 4871 | <50.0 |
| Nonanal | μg/kg | 34.8 | 39.6 | 37.9 | 60.3 | 26.3 |
| Trans-2-Nonenal | μg/kg | 142 | 102.6 | 152.4 | 46.8 | 27.9 |
| Decanal | μg/kg | 15.4 | 23.7 | 21.5 | 24.8 | 13.9 |
| (E,E)-2,4-Decadienal | μg/kg | 6.8 | 3.6 | 5.1 | 16.3 | 25.1 |
| Total Staling Aldehyde | μg/kg | 33743 | 7075 | 53447 | 305709 | 1752 |

Based on the values above and the differing grist types assessed, the available Strecker aldehyde in the malt and if 100% absorbed to the wort, the start of mash aldehyde in solution value may be as illustrated in Table 2, as follows:

TABLE 2

| | Strecker Aldehyde | Strecker Aldehyde |
|---|---|---|
| Grist Type | per kg Malt (μg/kg) | per Liter (μg/l) |
| Grist 1 | 40330.62 | 13138.93 |
| (Aldehyde-Optimized Grist) | | |
| Grist 2 | 50922.19 | 15752.37 |
| (Standard Grist) | | |

Grist 2 may contain Malt #1, Malt #3, Malt #4, and unmalted barley. Grist 1 trades a portion of Malt #1 and Malt #3 for Malt #2 to lower the overall Strecker aldehyde levels. In some embodiments, Malt #1 may correspond to a “Pilsner” malt, Malt #2 may correspond to a “Dextrin” malt, Malt #3 may correspond to a “Munich” malt, and Malt #4 may correspond to a “Crystal” malt. As can be appreciated, selection of a malt variety for the malt used in production can dramatically reduce the total staling aldehydes of the final nonalcoholic or low-alcohol beer product. The malt variety, which may include one or more of the malts above, may be selected to have a particular total staling aldehyde, or Strecker aldehyde, that is less than a predetermined amount to, for example, produce an “aldehyde-optimized” grist. In this selection, the total Strecker aldehyde levels of the “aldehyde-optimized” grist may be lower than the total Strecker aldehyde levels, or amount, associated with a “standard” grist.

Table 3, below, shows the brew Strecker aldehyde levels as a function of grist composition at each point in the hot side brewing process.

TABLE 3

| | Total Strecker | Total Strecker |
|---|---|---|
| | Aldehyde | Aldehyde |
| Grist Type | START of Boil | END of Boil |
| Grist 1 | 3974.2 μg/l | 1318.9 μg/l |
| (Aldehyde-Optimized Grist) | | |
| Grist 2 | 5291.2 μg/l | 4064.1 μg/l |
| (Standard Grist) | | |

Limitation of Amino Acid Precursors in Boiling:

As provided above, the present disclosure describes paying close attention to levels of protein contained within malted barley as characterized through measurement of FAN downstream of raw material selection within the brewing process. The method may include adding tannic acid to the kettle during boiling to promote the formation of polyphenol-protein complexes within the boil, which can be precipitated out upon cooling, removing haze forming proteins from the beer and giving improvements in haze formation over shelf life. It is an aspect of the present disclosure that the addition of tannic acid also give rise to an improvement in the worty character of nonalcoholic and low-alcohol beers. Similar to that of FAN control during raw materials selection, the present disclosure describes reducing the key starting material for the formation of Strecker aldehydes and thus producing a lower level of these key compounds in the final product irrespective of downstream processing conditions. Stated another way, the addition of tannic acid reduces the key starting material for the formation of Strecker aldehydes and thus a lower level of these key compounds are found in the final product irrespective of downstream processing conditions giving rise to an improvement in the worty character of the beer.

Table 4, below, shows staling aldehyde levels measured at lab scale in worts collected with and without tannic acid.

TABLE 4

| | | | Total | Total |
|---|---|---|---|---|
| | Total | Total | Staling | Staling |
| | Staling | Staling | Aldehyde | Aldehyde |
| | Aldehyde | Aldehyde | (with | (with |
| Grist | (No Additions) | (No Additions) | Tannic Acid) | Tannic Acid) |
| Type | (START boil) | (END boil) | (START boil) | (END boil) |
| Grist 1 | 3974.2 μg/l | 1318.9 μg/l | 2999.2 μg/l | 1591.8 μg/l |
| Grist 2 | 5291.2 μg/l | 4064.1 μg/l | 3303.8 μg/l | 2349.4 μg/l |

Control of Oxidative Conditions within Malt Mashing and Boiling:

Malt mashing may be performed under high temperature conditions (e.g., 64° C. to 72° C.), which may limit the solubility of oxygen in water and is generally considered a low oxygen environment and not one where oxygen would generally be considered to contribute to the Strecker degradation of amino acids in the wort. However, the inventors of the present disclosure found that introduction of an antioxidant into the mashing step, such as ascorbic acid, etc., leads to reduced levels of Strecker aldehyde formation. Although oxygen concentrations in the wort are low because of limited oxygen solubility, the temperature is high and thus kinetics of any degradation reactions utilizing oxygen are high.

In some embodiments, a sacrificial antioxidant may be introduced to the malt during mashing to control the off-flavors. For example, turbulence and mixing in the mash vessel means any oxygen used in degradation reaction can be replenished in the absence of an antioxidant and thus it is actually possible to form relatively high levels of Strecker aldehydes even in this low oxygen environment. Introduction of the sacrificial antioxidant to the mash essentially “mops up” any oxygen induced from mixing leading to less being available for Strecker degradation and thus lower levels being produced. In addition to providing protection from oxidative formation of Strecker aldehydes within the mash conversion vessel, the addition of an antioxidant such as ascorbic acid also helps protect via the same mechanism during wort transfers, boiling, filtration and in the whirlpool prior to entering the fermenter.

Table 5, below, shows staling aldehyde levels measured at lab scale in worts collected with and without ascorbic acid, both before and after boiling. This mechanism of protection is particularly effective when higher staling aldehyde levels are present within the grist.

TABLE 5

| | | | Total Staling | Total Staling |
|---|---|---|---|---|
| | Total Staling | Total Staling | Aldehyde | Aldehyde |
| | Aldehyde | Aldehyde | START of | END of |
| Grist | START of | END of | Boil (w/ | Boil (w/ |
| Type | Boil (No | Boil (No | Ascorbic | Ascorbic |
| Range | Additions) | Additions) | Acid) | Acid) |
| Grist | 3974.2 μg/l | 1318.2 μg/l | 3712.0 μg/l | 1177.9 μg/l |
| Range 1 | | | | |
| Grist | 5291.2 μg/l | 4064.1 μg/l | 4947.5 μg/l | 1920.3 μg/l |
| Range 2 | | | | |

Control of Oxidative Conditions within Fermentation and Cold Side Processes:

As with mashing, during the production of a regular beer, the fermenter or conditioning tank would be considered a low-oxygen environment and one with predominantly reducing conditions. In a typical fermentation Strecker Aldehydes may be reduced to higher alcohols and is one of the main mechanisms of worty flavor reduction in a typical alcoholic, or an alcohol by volume (“ABV”), beer. However, in nonalcoholic beers, employing low temperature “cold contact” fermentation conditions, the environment within the fermenter is vastly different. The absence of vigorous fermentation leads to a reduction in the amount of CO₂ production and thus gives the opportunity for higher levels of dissolved oxygen to be present within the liquid of the fermenter. In addition, the lower yeast activity eliminates the reductive mechanisms by which Strecker aldehydes are normally reduced to higher alcohols.

In a typical fermentation process, interventions are often to add oxygen to the fermenter to promote yeast growth. However, taking the nonintuitive approach described herein of adding an antioxidant into this stage in the brewing process limits oxidative degradation of FAN and the formation of Strecker aldehydes and does not negatively impact the cold contact fermentation process.

Although the temperature within a cold contact fermentation is low (e.g., 0° C. to 4° C.), limiting the kinetics of any oxidative formation of Strecker aldehydes, the addition of an antioxidant is surprisingly and advantageously effective. For instance, the low temperature allows a higher level of potential oxygen solubility, and the residence time in the fermenter is high, allowing time for significant degradation to occur in the absence of antioxidant addition.

In addition to protecting within the fermenter, the addition of the antioxidant (e.g., in the form of ascorbic acid, etc.) also helps protect from oxidative formation of Strecker aldehydes throughout the remainder of the downstream cold side processes such as centrifugation, cold conditioning, high gravity beer dilution, filtration, packaging, and pasteurization.

Overall Holistic Treatment Approach:

While each of the approaches described herein provide the ability to control the formation of worty off-flavors in nonalcoholic and low-alcohol beer, a holistic treatment of the brewing process and the combination of approaches (e.g., the selection of a particular malt variety producing an “aldehyde-optimized” grist, the addition of tannic acid during mashing of the malt and/or boiling of the wort, and the adding of an antioxidant, such as ascorbic acid, during mashing, etc.) leads to advantages in the overall performance achieved. Oxidative degradation of amino acids into Strecker aldehydes is a process that has the potential to occur at multiple stages in the brewing process and this minimization of this mechanism at all stages is described as being key to controlling, inhibiting, and even preventing the off-flavors described.

In addition to an appropriate malt selection to achieve the overall holistic protection mechanisms described above, the disclosure describes adding ascorbic acid, for example, dosed at a level of 3.75 g/kg to 4.6 g/kg of malt in the mash conversion vessel. In some embodiments, the ascorbic acid may be dosed at a level of 2.0 g/kg to 6.0 g/kg of malt. In some embodiments, tannic acid may be dosed at a range of 2.0 g/HL to 10 g/HL (e.g., of the finished low-alcohol or nonalcoholic beer product). In one embodiment, the tannic acid may be dosed at a range of 2.0 g/HL to 4.0 g/HL of the low-alcohol or nonalcoholic beer product. In one embodiment, the tannic acid may be dosed at a range of 2.5 g/HL to 3.5 g/HL to the low-alcohol or nonalcoholic beer product. It is an aspect of the present disclosure that brewing higher or lower gravities may require a proportional adjustment. As provided above, dosage of the tannic acid may be added to the mash tun, or mash conversion vessel, where the grist is mashed, the kettle where the wort is boiled, and/or during cold side processes (e.g., fermentation, filtration, etc.). In some embodiments, the tannic acid may added at the same time as other hot break stabilizers such as Irish moss, copper finings, etc.

This overall holistic treatment approach has been performed on pilot scale. Table 6, below, compares a brew using a stop fermentation approach to brewing a nonalcoholic or low-alcohol beer without the protection mechanisms described in this disclosure compared to a stop fermentation approach with the addition of the malt selection, ascorbic acid, and tannic acid additions as described herein. As shown in Table 6, below, the combination of malt selection, ascorbic acid, and tannic acid additions leads to a significant reduction in the quantities of Strecker aldehydes in the finished packaged beer compared to the product without such Strecker aldehyde control measures.

TABLE 6

| | Stop | | | | | | |
|---|---|---|---|---|---|---|---|
| | Fermentation | | | | | | |
| | Low-Alcohol | | | | | | |
| | Brew without | | | | | | |
| | Strecker | | | | | | |
| | Aldehyde | | | | | | |
| | Control | Stop Fermentation Low-Alcohol | | | | | |
| | Measures | Brew with Combination Strecker | | | | | |
| | (μg/l) | Aldehyde Control Measures (μg/l) | | | | | |
| | Control | Bottle | Bottle | Bottle | Bottle | Bottle | Bottle |
| Staling Aldehydes | Sample | 1 | 2 | 3 | 4 | 5 | 6 |
| 2-Methylpropanal | 182.1 | 104.58 | 115.23 | 98.27 | 117.43 | 118.28 | 114.29 |
| 2-Methylbutanal | 79.1 | 38.31 | 39.69 | 37.87 | 41.00 | 41.27 | 43.10 |
| 3-Methylbutanal | 189.5 | 93.30 | 95.53 | 89.68 | 88.59 | 89.54 | 102.72 |
| 2-Furfural | 601 | 291.62 | 320.87 | 325.97 | 373.58 | 366.84 | 331.80 |
| Methional | 37.2 | 124.02 | 119.86 | 105.53 | 93.41 | 98.34 | 139.17 |
| Phenylethanol | 80.8 | 48.48 | 49.73 | 40.40 | 39.07 | 40.02 | 51.29 |
| Total Staling | 1169.70 | 700.31 | 740.91 | 697.73 | 753.08 | 754.30 | 782.37 |

Aldehyde

As shown in Table 6, above, the total staling aldehydes in the nonalcoholic or low-alcohol beer product, produced by the combination of control measures disclosed herein (e.g., selecting a malt variety of a malt having a particular total staling aldehyde, adding an amount of tannic acid during boiling of the malt, and adding an antioxidant to the container while mashing the amount of malt, etc.) is measured to be less than 800 μg/1, which is less than the total staling aldehyde amount of the brew made without the control measures disclosed herein. As a result, the nonalcoholic or low-alcohol beer product produced using the combination of control measures (e.g., Bottles 1-6) provide a full complex beer flavor that is absent of the worty off-flavor commonly associated with conventional low-alcohol products.

The process, or method, of producing a low-alcohol or nonalcoholic beer product using stop fermentation with combination Strecker aldehyde control measures may comprise a number of the steps described above. In some embodiments, this method may comprise first selecting a malt variety of a malt having a particular total staling aldehyde. As described above and in conjunction with Table 1, different malt variations have varying total staling aldehyde amounts (e.g., measured in μg/kg). Selecting an appropriate malt variety may include selecting one or more malt varieties to form an “aldehyde-optimized” grist. Next, the method may proceed by mashing the selected aldehyde-optimized grist in a container (e.g., a mash tun, or mash conversion vessel). The process of mashing may introduce oxygen into the aldehyde-optimized grist. In some embodiments, an amount of tannic acid may be selected to add to the container. Additionally or alternatively, an amount of tannic acid may be added while the wort (e.g., formed from mashing the grist and then passing the resultant mash on to a lauter tun where a separation is performed producing the wort from the mash, etc.) is being boiled (e.g., at the start of the boil, at the end of the boil, etc., and/or some other time during boiling of the wort in the kettle). As provided above, the addition of tannic acid may precipitate precursors or inhibit reactions that lead to the formation of Strecker aldehydes in the low-alcohol or nonalcoholic beer. The inhibition of the formation of Strecker aldehydes may reduce the total amount of Strecker aldehydes when compared to an amount of Strecker aldehydes that form without adding the amount of tannic acid. In one embodiment, the tannic acid is added to the kettle during boiling of the wort and at an end of a predetermined boiling time period of the wort. The amount of tannic acid added to the kettle may be in a range of 2.0 g/HL to 10 g/HL, 2.0 g/HL to 4.0 g/HL, or 2.5 g/HL to 3.5 g/HL of the nonalcoholic or low-alcohol beer. Additionally or alternatively, the method may include adding an antioxidant to the container (e.g., a mash tun, or mash conversion vessel) while mashing the amount of grist (e.g., malt). The antioxidant may be ascorbic acid or the like. In one embodiment, the ascorbic acid may be added to the kettle at the end of the predetermined boiling time period of the wort. In some embodiments, an amount of the ascorbic acid added to the container may be dosed at a level of 2.0 g/kg to 6.0 g/kg of malt or, in some cases, at a level of 3.75 g/kg to 4.6 g/kg of malt in the container. The antioxidant may interact with a first portion of the oxygen. In some embodiments, a second portion of the oxygen that has not interacted with the antioxidant would be inadequate to form a predetermined amount of Strecker aldehyde in the low-alcohol or nonalcoholic beer.

The exemplary systems and methods of this disclosure have been described in relation to methods for controlling off-flavors in low-alcohol and nonalcoholic beer. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method of controlling off-flavors of low-alcohol beer, comprising: measuring free amino nitrogen (FAN) levels of a plurality of malted barley varieties; determining, based on a lowest measurement of FAN associated with a particular malted barley variety or combination of malted barley varieties in the plurality of malted barley varieties, a select malted barley variety; and adding, during mashing of the malted barley, an amount of tannic acid to the kettle, wherein the amount of tannic acid precipitates precursors or inhibits reactions that lead to the formation of Strecker aldehydes in the low-alcohol beer.

Embodiments include a method of controlling off-flavors of low-alcohol beer, comprising: mashing a selected malted barley variety in a mash conversion vessel forming a mash; separating the mash forming a wort; transferring the wort to a kettle; and adding, during boiling of the wort, an amount of tannic acid to the wort in the kettle, wherein the amount of tannic acid precipitates precursors or inhibits reactions that lead to the formation of Strecker aldehydes in the low-alcohol beer.

Aspects of the above method include wherein the precipitation of the precursors or the inhibition of the reactions reduce a total amount of Strecker aldehydes in the low-alcohol beer when compared to an amount of Strecker aldehydes that form in the low-alcohol beer without adding the amount of tannic acid.

Embodiments include a method of controlling off-flavors in beer, comprising: mashing an amount of malt in a container, wherein the mashing introduces oxygen into the malt; and adding an antioxidant to the container while mashing the amount of malt, wherein the antioxidant interacts with a first portion of the oxygen, and wherein a second portion of the oxygen that has not interacted with the antioxidant is inadequate to form a predetermined amount of Strecker aldehydes.

Aspects of the above method include wherein the antioxidant is ascorbic acid.

Embodiments include a method of controlling off-flavors in nonalcoholic or low-alcohol beer, comprising: selecting a malt variety of a malt having a particular total staling aldehyde; mashing the malt variety in a container forming a mash, wherein mashing the malt variety introduces oxygen into the mash; adding an antioxidant to the mash in the container while mashing the malt variety, wherein the antioxidant interacts with a first portion of the oxygen, and wherein a second portion of the oxygen that has not interacted with the antioxidant is inadequate to form a predetermined amount of Strecker aldehyde in the nonalcoholic beer; and adding an amount of tannic acid, wherein the amount of tannic acid precipitates precursors or inhibits reactions that lead to the formation of Strecker aldehydes in the nonalcoholic beer.

Aspects of the above method include wherein, after adding the antioxidant and the amount of tannic acid, a measurement of total staling aldehydes in the nonalcoholic beer is less than 800 μg/l. Aspects of the above method include wherein the precipitation of the precursors or the inhibition of the reactions reduce a total amount of Strecker aldehydes in the nonalcoholic beer when compared to an amount of Strecker aldehydes in the nonalcoholic beer that form without adding the amount of tannic acid. Aspects of the above method include wherein the antioxidant is ascorbic acid, and wherein an amount of the ascorbic acid added to the container is dosed at a level of 3.75 g/kg to 4.6 g/kg of malt in the container. Aspects of the above method include wherein the amount of tannic acid is added to the container while mashing the malt variety in the container. Aspects of the above method include wherein after mashing the malt variety, the method further comprises: separating the mash forming a wort; and transferring the wort to a kettle, wherein the amount of tannic acid is added to the wort in the kettle during boiling of the wort. Aspects of the above method include wherein the amount of tannic acid added is in a range of 2.0 g/HL to 4.0 g/HL of the nonalcoholic beer. Aspects of the above method include wherein the amount of tannic acid added is in a range of 2.5 g/HL to 3.5 g/HL of the nonalcoholic beer. Aspects of the above method include wherein the amount of tannic acid added is added to the wort at an end of a predetermined boiling time period of the wort.

Embodiments include a nonalcoholic or a low-alcohol beer product made by one or more of the methods as substantially disclosed herein.

Aspects of the above nonalcoholic or low-alcohol beer product include wherein a measurement of total staling aldehydes in the nonalcoholic or low-alcohol beer is less than 800 μg/l. Aspects of the above nonalcoholic or low-alcohol beer product include wherein a total alcohol by volume (ABV) of the nonalcoholic or low-alcohol beer product is less than 1%, preferably less than 0.05% ABV. Aspects of the above nonalcoholic or low-alcohol beer product include wherein the total ABV of the nonalcoholic or low-alcohol beer product is less than or equal to 0.03% ABV.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably and include any type of methodology, process, mathematical operation or technique.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein.

What is claimed is:

1. A method of controlling off-flavors of low-alcohol beer, comprising:
mashing a selected malted barley variety in a mash conversion vessel forming a mash;
separating the mash forming a wort;
transferring the wort to a kettle; and
adding, during boiling of the wort, an amount of tannic acid to the wort in the kettle, wherein the amount of tannic acid precipitates precursors or inhibits reactions that lead to the formation of Strecker aldehydes in the low-alcohol beer.

2. The method of claim 1, wherein the precipitation of the precursors or the inhibition of the reactions reduce a total amount of Strecker aldehydes in the low-alcohol beer when compared to an amount of Strecker aldehydes that form in the low-alcohol beer without adding the amount of tannic acid.

3. A method of controlling off-flavors in beer, comprising:
mashing an amount of malt in a container, wherein the mashing introduces oxygen into the malt; and
adding an antioxidant to the container while mashing the amount of malt, wherein the antioxidant interacts with a first portion of the oxygen, and wherein a second portion of the oxygen that has not interacted with the antioxidant is inadequate to form a predetermined amount of Strecker aldehydes.

4. The method of claim 3, wherein the antioxidant is ascorbic acid.

5. A method of controlling off-flavors in nonalcoholic beer, comprising:
selecting a malt variety of a malt having a particular total staling aldehyde;
mashing the malt variety in a container forming a mash, wherein mashing the malt variety introduces oxygen into the mash;
adding an antioxidant to the mash in the container while mashing the malt variety, wherein the antioxidant interacts with a first portion of the oxygen, and wherein a second portion of the oxygen that has not interacted with the antioxidant is inadequate to form a predetermined amount of Strecker aldehyde in the nonalcoholic beer; and
adding an amount of tannic acid, wherein the amount of tannic acid precipitates precursors or inhibits reactions that lead to the formation of Strecker aldehydes in the nonalcoholic beer.

6. The method of claim 5, wherein, after adding the antioxidant and the amount of tannic acid, a measurement of total staling aldehydes in the nonalcoholic beer is less than 800 μg/l.

7. The method of claim 5, wherein the precipitation of the precursors or the inhibition of the reactions reduce a total amount of Strecker aldehydes in the nonalcoholic beer when compared to an amount of Strecker aldehydes in the nonalcoholic beer that form without adding the amount of tannic acid.

8. The method of claim 7, wherein the antioxidant is ascorbic acid, and wherein an amount of the ascorbic acid added to the container is dosed at a level of 3.75 g/kg to 4.6 g/kg of malt in the container.

9. The method of claim 7, wherein the amount of tannic acid is added to the container while mashing the malt variety in the container.

10. The method of claim 7, wherein after mashing the malt variety, the method further comprises:
separating the mash forming a wort; and
transferring the wort to a kettle, wherein the amount of tannic acid is added to the wort in the kettle during boiling of the wort.

11. The method of claim 10, wherein the amount of tannic acid added is in a range of 2.0 g/HL, to 4.0 g/HL, of the nonalcoholic beer.

12. The method of claim 10, wherein the amount of tannic acid added is added to the wort at an end of a predetermined boiling time period of the wort.
